(19) United States
(12) Patent Application Publication
(10) Pub. No.: US 2020/0309548 A1
(43) Pub. Date: Oct. 1, 2020

(54) CONTROL APPARATUS, CONTROL METHOD, AND NON-TRANSITORY COMPUTER-READABLE STORAGE MEDIUM STORING PROGRAM

(71) Applicant: HONDA MOTOR CO., LTD., Tokyo (JP)

(72) Inventors: Hidekazu SHINTANI, Wako-shi (JP); Naohide AIZAWA, Tokyo (JP); Mafuyu KOSEKI, Tokyo (JP); Takaaki ISHIKAWA, Wako-shi (JP)

(21) Appl. No.: 16/814,031

(22) Filed: Mar. 10, 2020

(30) Foreign Application Priority Data
Mar. 28, 2019 (JP) 2019-064035

(51) Int. Cl. G01C 21/34; G01C 21/36; G06K 9/00

(52) U.S. Cl. CPC G01C 21/3415; G01C 21/3691; G06K 9/00832; G01C 21/3608; G01C 21/3617; G01C 21/3469

(57) ABSTRACT

A control apparatus comprises: a generation circuit configured to generate a route plan of a vehicle; and a control circuit configured to control the generation circuit to change the route plan of the vehicle generated by the generation circuit because of at least one of vehicle information of the vehicle, information of an occupant of the vehicle, and information concerning an environment on the route plan as a factor.

### CROSS-REFERENCE TO RELATED APPLICATION

This application claims priority to and the benefit of Japanese Patent Application No. 2019-064035 filed on Mar. 28, 2019, the entire disclosure of which is incorporated herein by reference.

### BACKGROUND OF THE INVENTION

### Field of the Invention

The present invention relates to a control apparatus capable of generating a traveling route of a vehicle, a control method, and a non-transitory computer-readable storage medium storing a program.

### Description of the Related Art

There is recently known a route generation system using the biological information, intention, or characteristic of an occupant of a vehicle. Japanese Patent Laid-Open No. 2016-137201 describes an arrangement that detects a plurality of kinds of biological information of an occupant and stores the transition of the feeling change in the occupant. Japanese Patent Laid-Open No. 2018-77207 describes a route processing apparatus capable of deciding a recommended route suitable for the past intention, past tendency, or past unique characteristic of a driver. Japanese Patent Laid-Open No. 11-6741 describes a navigation device that learns the rest characteristic of an individual at the time of driving and uses the rest characteristic to calculate a required time with a margin considering acquisition of a rest period.

However, there is room for improvement on an arrangement that flexibly changes a route in accordance with various events that can occur during traveling to a destination.

### SUMMARY OF THE INVENTION

The present invention provides a control apparatus that flexibly changes a route in accordance with a factor that occurs during traveling to a destination, a control method, and a non-transitory computer-readable storage medium storing a program.

The present invention in its first aspect provides a control apparatus comprising: a generation circuit configured to generate a route plan of a vehicle; and a control circuit configured to control the generation circuit to change the route plan of the vehicle generated by the generation circuit because of at least one of vehicle information of the vehicle, information of an occupant of the vehicle, and information concerning an environment on the route plan as a factor.

The present invention in its second aspect provides a control method executed by a control apparatus, comprising: generating a route plan of a vehicle; and controlling to change the generated route plan of the vehicle because of at least one of vehicle information of the vehicle, information of an occupant of the vehicle, and information concerning an environment on the route plan as a factor.

The present invention in its third aspect provides a non-transitory computer-readable storage medium storing a program configured to cause a computer to operate to: generate a route plan of a vehicle; and control to change the generated route plan of the vehicle because of at least one of vehicle information of the vehicle, information of an occupant of the vehicle, and information concerning an environment on the route plan as a factor.

According to the present invention, it is possible to flexibly change a route in accordance with a factor that occurs during traveling to a destination.

### BRIEF DESCRIPTION OF THE DRAWINGS

FIG. 1 is a view showing the arrangement of a navigation system;

FIG. 2 is a view showing the arrangement of a vehicle control apparatus;

FIG. 3 is a block diagram showing the functional blocks of a control unit;

FIG. 4 is a block diagram showing the arrangement of a server;

FIG. 5 is a flowchart showing processing of the navigation system;

FIG. 6 is a flowchart showing processing of route change;

FIG. 7 is a flowchart showing processing of spot evaluation;

FIG. 8 is a flowchart showing processing of monitoring utterance contents;

FIGS. 9A and 9B are flowcharts showing processing of monitoring an image in a vehicle;

FIG. 10 is a flowchart showing processing of monitoring vehicle information, traffic information, and environment information;

FIG. 11 is a flowchart showing processing of monitoring the state of an occupant;

FIG. 12 is a flowchart showing processing of route candidate generation; and

FIG. 13 is a view showing a screen configured to make a message notification.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

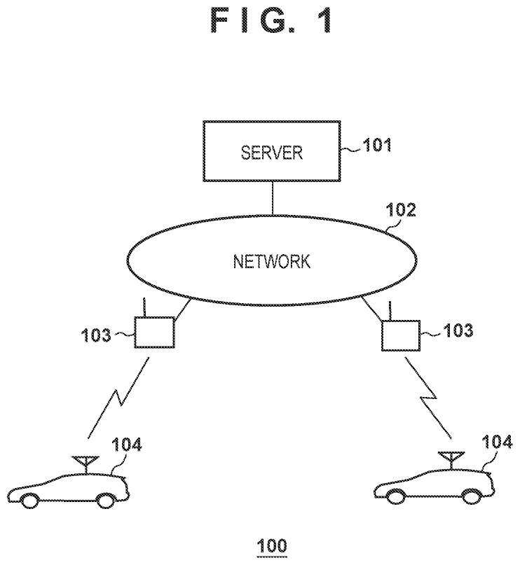

FIG. 1 is a view showing the arrangement of a navigation system 100 according to this embodiment. As shown in FIG. 1, the navigation system 100 includes a server 101, a base station 103, and a vehicle 104. The server 101 is a server capable of providing a navigation service according to this embodiment to the vehicle 104, and provides a navigation function to the vehicle 104. The vehicle 104 can communicate with the server 101 via a network 102, and receives the navigation service from the server 101.

The base station 103 is a base station provided in, for example, an area where the server 101 can provide the navigation service, and can communicate with the vehicle 104. In addition, the server 101 is configured to be communicable with the base station 103 via the network 102 that is a wired or wireless network or includes both of them. With this arrangement, for example, the vehicle 104 can transmit vehicle information such as GPS position information to the server 101, and the server 101 can transmit navigation screen data or the like to the vehicle 104. The server 101 and the vehicle 104 can also be connected to a network other than the network 102 shown in FIG. 1, and can be connected to, for example, the Internet. Additionally, the server 101 can acquire a web search result or SNS information of a user (corresponding to the occupant of the vehicle 104) registered in advance, and acquire schedule information, the search tendency (taste) of the user, and the like.

The navigation system 100 may include a component other than those shown in FIG. 1. For example, a road side unit provided along a road may be connected to the network 102. Such a road side unit can perform vehicle-to-infrastructure communication with the vehicle 104 by, for example, DSRC (Dedicated Short Range Communication), and is used to transfer the vehicle information of the vehicle 104 to the server 101 or used to transmit state information (for example, a crack) of a road surface to the server 101.

FIG. 1 shows only one server 101. However, the server 101 may be formed by a plurality of apparatuses. In addition, FIG. 1 shows only two vehicles 104. However, the number of vehicles is not limited to the illustrated one as long as the server 101 can provide the navigation service.

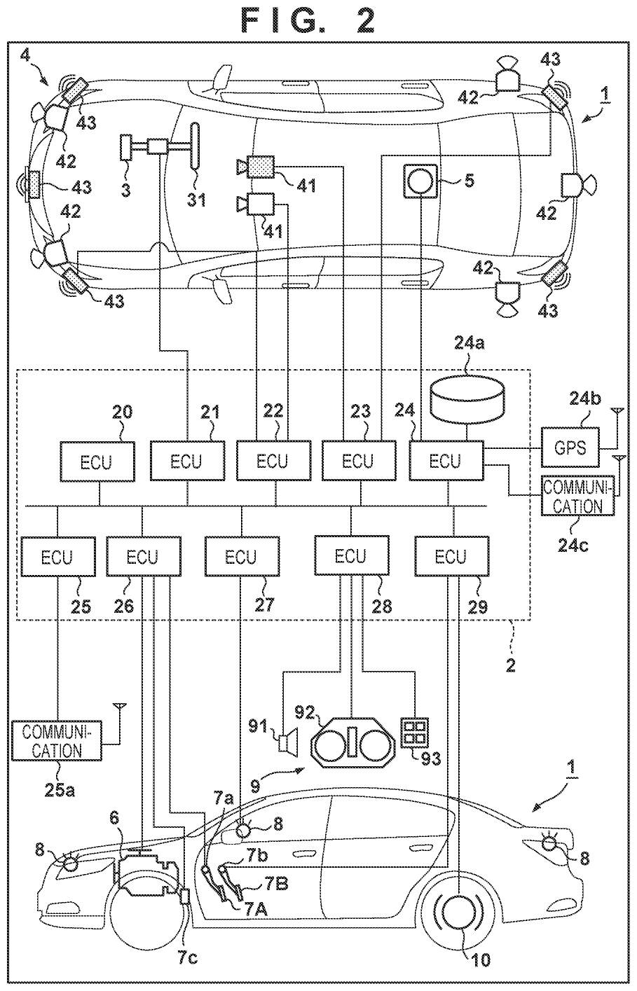

FIG. 2 is a block diagram of a vehicle control apparatus (traveling control apparatus) according to an embodiment of the present invention, and a vehicle 1 is controlled. The vehicle 1 shown in FIG. 2 corresponds to the vehicle 104 shown in FIG. 1. FIG. 2 shows the outline of the vehicle 1 by a plan view and a side view. The vehicle 1 is, for example, a sedan-type four-wheeled vehicle.

The traveling control apparatus shown in FIG. 2 includes a control unit 2. The control unit 2 includes a plurality of ECUs 20 to 29 communicably connected by an in-vehicle network. Each ECU includes a processor represented by a CPU, a storage device such as a semiconductor memory, an interface with an external device, and the like. The storage device stores programs to be executed by the processor, data to be used by the processor for processing, and the like. Each ECU may include a plurality of processors, storage devices, and interfaces.

The functions and the like provided by the ECUs 20 to 29 will be described below. Note that the number of ECUs and the provided functions can be appropriately designed, and they can be subdivided or integrated as compared to this embodiment.

The ECU 20 executes control associated with automated driving of the vehicle 1. In automated driving, at least one of steering and acceleration/deceleration of the vehicle 1 is automatically controlled.

The ECU 21 controls an electric power steering device 3. The electric power steering device 3 includes a mechanism that steers front wheels in accordance with a driving operation (steering operation) of a driver on a steering wheel 31. In addition, the electric power steering device 3 includes a motor that generates a driving force to assist the steering operation or automatically steer the front wheels, and a sensor that detects the steering angle. If the driving state of the vehicle 1 is automated driving, the ECU 21 automatically controls the electric power steering device 3 in correspondence with an instruction from the ECU 20 and controls the direction of travel of the vehicle 1.

The ECUs 22 and 23 perform control of detection units 41 to 43 that detect the peripheral state of the vehicle and information processing of detection results. Each detection unit 41 is a camera (to be sometimes referred to as the camera 41 hereinafter) that captures the front side of the vehicle 1. In this embodiment, the cameras 41 are attached to the windshield inside the vehicle cabin at the roof front of the vehicle 1. When images captured by the cameras 41 are analyzed, for example, the contour of a target or a division line (a white line or the like) of a lane on a road can be extracted.

The detection unit 42 is Light Detection and Ranging (LIDAR), and detects a target around the vehicle 1 or measures the distance to a target. In this embodiment, five detection units 42 are provided; one at each corner of the front portion of the vehicle 1, one at the center of the rear portion, and one on each side of the rear portion. The detection unit 43 is a millimeter wave radar (to be sometimes referred to as the radar 43 hereinafter), and detects a target around the vehicle 1 or measures the distance to a target. In this embodiment, five radars 43 are provided; one at the center of the front portion of the vehicle 1, one at each corner of the front portion, and one at each corner of the rear portion.

The ECU 22 performs control of one camera 41 and each detection unit 42 and information processing of detection results. The ECU 23 performs control of the other camera 41 and each radar 43 and information processing of detection results. Since two sets of devices that detect the peripheral state of the vehicle are provided, the reliability of detection results can be improved. In addition, since detection units of different types such as cameras and radars are provided, the peripheral environment of the vehicle can be analyzed multilaterally.

The ECU 24 performs control of a gyro sensor 5, a GPS sensor 24b, and a communication device 24c and information processing of detection results or communication results. The gyro sensor 5 detects a rotary motion of the vehicle 1. The course of the vehicle 1 can be determined based on the detection result of the gyro sensor 5, the wheel speed, or the like. The GPS sensor 24b detects the current position of the vehicle 1. The communication device 24c performs wireless communication with a server that provides map information, traffic information, and meteorological information and acquires these pieces of information. The ECU 24 can access a map information database 24a formed in the storage device. The ECU 24 searches for a route from the current position to the destination. Note that databases for the above-described traffic information, meteorological information, and the like may be formed in the database 24a.

The ECU 25 includes a communication device 25a for inter-vehicle communication. The communication device 25a performs wireless communication with another vehicle on the periphery and performs information exchange between the vehicles. The communication device 25a has various kinds of functions, and has, for example, a DSRC (Dedicated Short Range Communication) function and a cellular communication function. The communication device 25a may be formed as a TCU (Telematics Communication Unit) including a transmission/reception antenna.

The ECU 26 controls a power plant 6. The power plant 6 is a mechanism that outputs a driving force to rotate the driving wheels of the vehicle 1 and includes, for example, an engine and a transmission. The ECU 26, for example, controls the output of the engine in correspondence with a driving operation (accelerator operation or acceleration operation) of the driver detected by an operation detection sensor 7a provided on an accelerator pedal 7A, or switches the gear ratio of the transmission based on information such as a vehicle speed detected by a vehicle speed sensor 7c. If the driving state of the vehicle 1 is automated driving, the ECU 26 automatically controls the power plant 6 in correspondence with an instruction from the ECU 20 and controls the acceleration/deceleration of the vehicle 1.

The ECU 27 controls lighting devices (headlights, taillights, and the like) including direction indicators 8 (turn signals). In the example shown in FIG. 2, the direction indicators 8 are provided in the front portion, door mirrors, and the rear portion of the vehicle 1.

The ECU 28 controls an input/output device 9. The input/output device 9 outputs information to the driver and accepts input of information from the driver. A voice output device 91 notifies the driver of the information by voice. A display device 92 notifies the driver of information by displaying an image. The display device 92 is arranged, for example, in front of the driver's seat and constitutes an instrument panel or the like. Note that although a voice and display have been exemplified here, the driver may be notified of information using a vibration or light. Alternatively, the driver may be notified of information by a combination of some of the voice, display, vibration, and light. Furthermore, the combination or the notification form may be changed in accordance with the level (for example, the degree of urgency) of information of which the driver is to be notified. In addition, the display device 92 may include a navigation device.

An input device 93 is a switch group that is arranged at a position where the driver can perform an operation, is used to issue an instruction to the vehicle 1, and may also include a voice input device such as a microphone.

The ECU 29 controls a brake device 10 and a parking brake (not shown). The brake device 10 is, for example, a disc brake device which is provided for each wheel of the vehicle 1 and decelerates or stops the vehicle 1 by applying a resistance to the rotation of the wheel. The ECU 29, for example, controls the operation of the brake device 10 in correspondence with a driving operation (brake operation) of the driver detected by an operation detection sensor 7b provided on a brake pedal 7B. If the driving state of the vehicle 1 is automated driving, the ECU 29 automatically controls the brake device 10 in correspondence with an instruction from the ECU 20 and controls deceleration and stop of the vehicle 1. The brake device 10 or the parking brake can also be operated to maintain the stop state of the vehicle 1. In addition, if the transmission of the power plant 6 includes a parking lock mechanism, it can be operated to maintain the stop state of the vehicle 1.

Control concerning automated driving of the vehicle 1 executed by the ECU 20 will be described. When the driver instructs a destination and automated driving, the ECU 20 automatically controls traveling of the vehicle 1 to the destination in accordance with a guidance route searched by the ECU 24. In the automatic control, the ECU 20 acquires information (outside information) concerning the peripheral state of the vehicle 1 from the ECUs 22 and 23, recognizes it, and controls steering and acceleration/deceleration of the vehicle 1 by issuing instructions to the ECUs 21, 26, and 29 based on the acquired information and the recognition result.

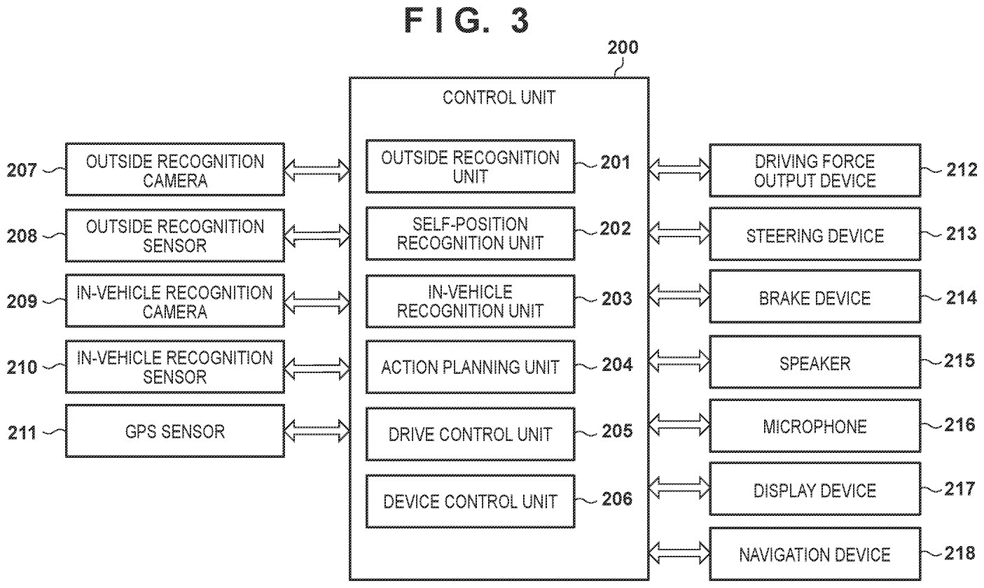

FIG. 3 is a block diagram showing the functional blocks of the control unit 2. A control unit 200 corresponds to the control unit 2 shown in FIG. 2, and includes an outside recognition unit 201, a self-position recognition unit 202, an in-vehicle recognition unit 203, an action planning unit 204, a driving control unit 205, and a device control unit 206. Each block is implemented by one or a plurality of ECUs shown in FIG. 2.

The outside recognition unit 201 recognizes the outside information of the vehicle 1 based on signals from an outside recognition camera 207 and an outside recognition sensor 208. Here, the outside recognition camera 207 corresponds to, for example, the camera 41 shown in FIG. 2, and the outside recognition sensor 208 corresponds to, for example, the detection units 42 and 43 shown in FIG. 2. The outside recognition unit 201 recognizes, for example, a scene such as an intersection, a railroad crossing, or a tunnel, a free space such as a road shoulder, and the behavior (the speed, the direction of travel, and the like) of another vehicle based on the signals from the outside recognition camera 207 and the outside recognition sensor 208. The self-position recognition unit 202 recognizes the current position of the vehicle 1 based on a signal from a GPS sensor 211. Here, the GPS sensor 211 corresponds to, for example, the GPS sensor 24b shown in FIG. 2.

The in-vehicle recognition unit 203 identifies the occupant of the vehicle 1 based on signals from an in-vehicle recognition camera 209 and an in-vehicle recognition sensor 210 and recognizes the state of the occupant. The in-vehicle recognition camera 209 is, for example, a near infrared camera installed on the display device 92 inside the vehicle 1, and, for example, detects the direction of the sight line of the occupant from captured image data. In addition, the in-vehicle recognition sensor 210 is, for example, a sensor configured to detect a biological signal of the occupant and acquire biological information. Biological information is, for example, information concerning a living body such as a pulse, a heart rate, a body weight, a body temperature, a blood pressure, or sweating. The in-vehicle recognition sensor 210 may acquire such information concerning a living body from, for example, a wearable device of the occupant. The in-vehicle recognition unit 203 recognizes a drowsy state of the occupant, a working state other than driving, or the like based on the signals.

The action planning unit 204 plans an action of the vehicle 1 such as an optimum route or a risk avoiding route based on the results of recognition by the outside recognition unit 201 and the self-position recognition unit 202. The action planning unit 204, for example, performs entering determination based on the start point or end point of an intersection, a railroad crossing, or the like, and makes an action plan based on a prediction result of the behavior of another vehicle. The driving control unit 205 controls a driving force output device 212, a steering device 213, and a brake device 214 based on the action plan made by the action planning unit 204. Here, the driving force output device 212 corresponds to, for example, the power plant 6 shown in FIG. 2, the steering device 213 corresponds to the electric power steering device 3 shown in FIG. 2, and the brake device 214 corresponds to the brake device 10.

The device control unit 206 controls devices connected to the control unit 200. For example, the device control unit 206 controls a speaker 215 and a microphone 216 to make them output a predetermined voice message such as a message for a warning or navigation or detect a voice signal uttered by the occupant in the vehicle and acquire voice data. In addition, the device control unit 206 controls a display device 217 to make it display a predetermined interface screen. The display device 217 corresponds to, for example, the display device 92. Additionally, for example, the device control unit 206 controls a navigation device 218 to acquire setting information in the navigation device 218.

The control unit 200 may include a functional block other than those shown in FIG. 3, and may include, for example, an optimum route calculation unit configured to calculate an optimum route to a destination based on map information acquired via the communication device 24c. The control unit 200 may acquire information from a device other than the cameras and the sensors shown in FIG. 3, and may, for example, acquire the information of another vehicle via the communication device 25a. In addition, the control unit 200 receives detection signals not only from the GPS sensor 211 but also from various kinds of sensors provided in the vehicle 1. For example, the control unit 200 receives a detection signal from a door open/close sensor or a door lock mechanism sensor provided in a door portion of the vehicle 1 via an ECU formed in the door portion. The control unit 200 can thus detect unlock of the door or a door opening/closing operation.

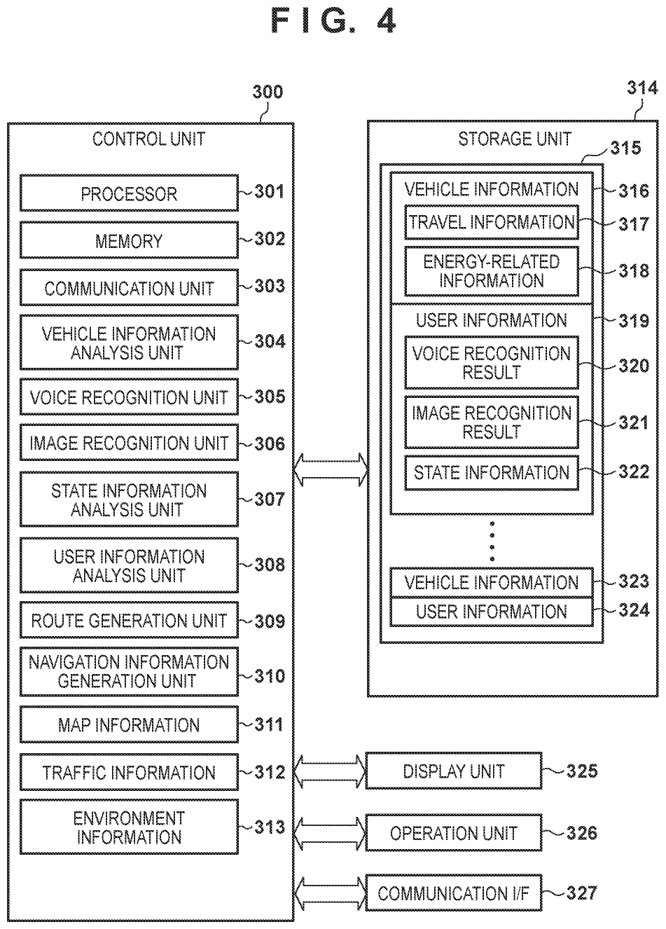

FIG. 4 is a block diagram showing the block arrangement of the server 101. A control unit 300 is a controller including a CPU or a GPU and memories such as a ROM and a RAM, and comprehensively controls the server 101. The server 101 can be a computer that executes the present invention. Additionally, in this embodiment, at least part of the arrangement of the server 101 that can be an example of the control apparatus or the arrangement of the server 101 may be included in the vehicle 104. That is, the arrangement as the control apparatus may be formed inside the vehicle 104 or outside the vehicle 104, or may be distributed to both the outside and the inside of the vehicle 104 so as to cooperatively operate. For example, a processor 301 serving as a CPU loads a control program stored in the ROM into the RAM and executes it, thereby implementing an operation according to this embodiment. The blocks in the control unit 300 may include, for example, a GPU. A display unit 325 is, for example, a display and displays various kinds of user interface screens. An operation unit 326 is, for example, a keyboard or a pointing device, and accepts a user operation. A communication interface (I/F) 327 is an interface configured to enable communication with the network 102. For example, the server 101 can acquire various kinds of data to be described later from the vehicle 104 via the communication I/F 327.

The processor 301 executes a program stored in, for example, a memory 302, thereby comprehensively controlling the blocks in the control unit 300. For example, the processor 301 controls to acquire various kinds of data to be described below from the vehicle 104, and after the acquisition, instructs a corresponding block to analyze the data. A communication unit 303 controls communication with the outside. The outside includes not only the network 102 but also another network. The communication unit 303 can communicate with, for example, the vehicle 104 or another device connected to the network 102 and also another server connected to another network such as the Internet or a portable telephone system.

A vehicle information analysis unit 304 acquires vehicle information, for example, GPS position information and speed information from the vehicle 104, and analyzes the behavior. A voice recognition unit 305 performs voice recognition processing based on voice data obtained by converting a voice signal uttered by the occupant of the vehicle 104 and transmitting it. For example, the voice recognition unit 305 classifies words uttered by the occupant of the vehicle 104 into feelings such as joy, anger, grief, and pleasure, and stores the classification result as a voice recognition result 320 (voice information) of user information 319 in association with a result of analysis (the position, time, and the like of the vehicle 104) by the vehicle information analysis unit 304. In this embodiment, the occupant includes the driver of the vehicle 104 and an occupant other than the driver. An image recognition unit 306 performs image recognition processing based on image data captured in the vehicle 104. Here, the image includes a still image and a moving image. For example, the image recognition unit 306 recognizes a smiling face from face images of the occupant of the vehicle 104, and stores the recognition result as an image recognition result 321 (image information) of the user information 319 in association with the analysis result (the position of the vehicle 104, a time, and the like) by the vehicle information analysis unit 304.

A state information analysis unit 307 analyzes state information of the occupant of the vehicle 104. Here, the state information includes biological information such as a pulse, a heart rate, and a body weight. In addition, the state information includes information about a time of eating/drinking by the occupant of the vehicle 104 or a time of use of a restroom. For example, the state information analysis unit 307 stores the heart rate of the occupant of the vehicle 104 as state information 322 of the user information 319 in association with an analysis result (the position of the vehicle 104, a time, and the like) by the vehicle information analysis unit 304. In addition, for example, the state information analysis unit 307 can perform various kinds of analysis for the state information 322, and detect that, for example, the rising rate of the heart rate per unit time is equal to or more than a threshold.

A user information analysis unit 308 performs various kinds of analysis for the user information 319 stored in a storage unit 314. For example, based on the voice recognition result 320 and the image recognition result 321 of the user information 319, the user information analysis unit 308 acquires the contents of an utterance from the occupant concerning the neighborhood (for example, a seaside roadway) of the traveling route of the vehicle 104 or a place (a destination or a way point) that the vehicle 104 has visited, or analyzes the feeling of the occupant from the tone or tempo of a conversation, the facial expression of the occupant, and the like. In addition, for example, based on the contents that the occupant has uttered concerning the neighborhood of the traveling route of the vehicle 104 or the place that the vehicle 104 has visited, and a feeling acquired from the voice recognition result 320 and the image recognition result 321 at that time, the user information analysis unit 308 analyzes the taste (the tendency of the taste) of the user, for example, that the user has satisfied the place that the user has visited or traveled. The analysis result obtained by the user information analysis unit 308 is stored as the user information 319 and used for, for example, selection of a destination or learning after the end of the navigation service.

A route generation unit 309 generates a route for traveling of the vehicle 104. A navigation information generation unit 310 generates navigation display data to be displayed on the navigation device 218 of the vehicle 104 based on the route generated by the route generation unit 309. For example, the route generation unit 309 generates a route from the current point to the destination based on the destination acquired from the vehicle 104. In this embodiment, for example, when a destination is input to the navigation device 218 in the place of departure, for example, a route passing along by a sea, on which the taste of the occupant of the vehicle 104 is reflected, is generated. For example, if it is estimated during the movement to the destination that the vehicle cannot arrive at the destination in time because of traffic congestion or the like, an alternate route to the destination is generated. For example, if a fatigue state of the occupant of the vehicle 104 is recognized during the movement of the destination, a rest place is searched for, and a route to the rest place is generated.

Map information 311 is information of a road network or a facility concerning a road, and, for example, a map database used for the navigation function or the like may be used. Traffic information 312 is information concerning a traffic, and is, for example, traffic congestion information or traffic regulation information by a road construction or an event. Environment information 313 is information concerning an environment, and is, for example, meteorological information (an atmospheric temperature, a humidity, a weather, a wind speed, visual field information by a dense fog, rainfall, snowfall, or the like, disaster information, and the like). The environment information 313 also includes attribute information concerning a facility or the like. For example, the attribute information includes the current number of visitors in an amusement facility such as an amusement park and sudden closure information based on the weather, which can be made public on the Internet or the like. The map information 311, the traffic information 312, and the environment information 313 may be acquired from, for example, another server connected to the network 102.

The storage unit 314 is a storage area used to store programs and data necessary for the server 101 to operate. In addition, the storage unit 314 forms a database 315 based on vehicle information acquired from the vehicle 104 and user information acquired from the occupant of the vehicle 104.

The database 315 is a database including a set of information concerning the vehicle 104 and information concerning the occupant of the vehicle 104. That is, in the navigation system 100, when a certain vehicle 104 has traveled from a place of departure to a destination, a set of information concerning the vehicle 104 and information concerning the occupant of the vehicle 104 is stored in the database 315. That is, the database 315 includes a plurality of sets including a set of vehicle information 316 and the user information 319 for a certain vehicle 104 and a set of vehicle information 323 and user information 324 for another vehicle 104. If the same occupant has made the vehicle 104 travel in different days, different sets of information are stored.

The vehicle information 316 includes travel information 317 and energy-related information 318. The travel information 317 includes, for example, the GPS position information and the speed information of the vehicle 104, and the energy-related information 318 includes the remaining amount of the fuel of the vehicle 104 and the remaining capacity of an in-vehicle battery. The user information 319 includes the voice recognition result 320, the image recognition result 321, and the state information 322 described above. The analysis result by the user information analysis unit 308 is also stored as the user information 319. The vehicle information 316 and the user information 319 are updated any time during traveling of the vehicle 104 from the place of departure to the destination. Even after the end of the navigation service, the vehicle information 316 and the user information 319 are held in the database 315 and used for learning by the user information analysis unit 308.

For example, after the end of the navigation service, the user information analysis unit 308 learns the tendency of the time of eating/drinking by the occupant of the vehicle 104 or the frequency or interval of use of a restroom based on the vehicle information 316 and the user information 319 held in the database 315. Then, for example, when the navigation service is executed next, the route generation unit 309 generates a route using the learning result. For example, the route generation unit 309 generates the route to the destination such that the vehicle can pass a restaurant that suits the taste of the occupant of the vehicle 104 at the time when the occupant wants to eat/drink. In addition, if it is learned that the frequency of occupant's use of a restroom is relatively high, the route generation unit 309 generates a route optimized to pass a rest place in accordance with the time needed according to the distance up to the destination when the navigation service is executed next.

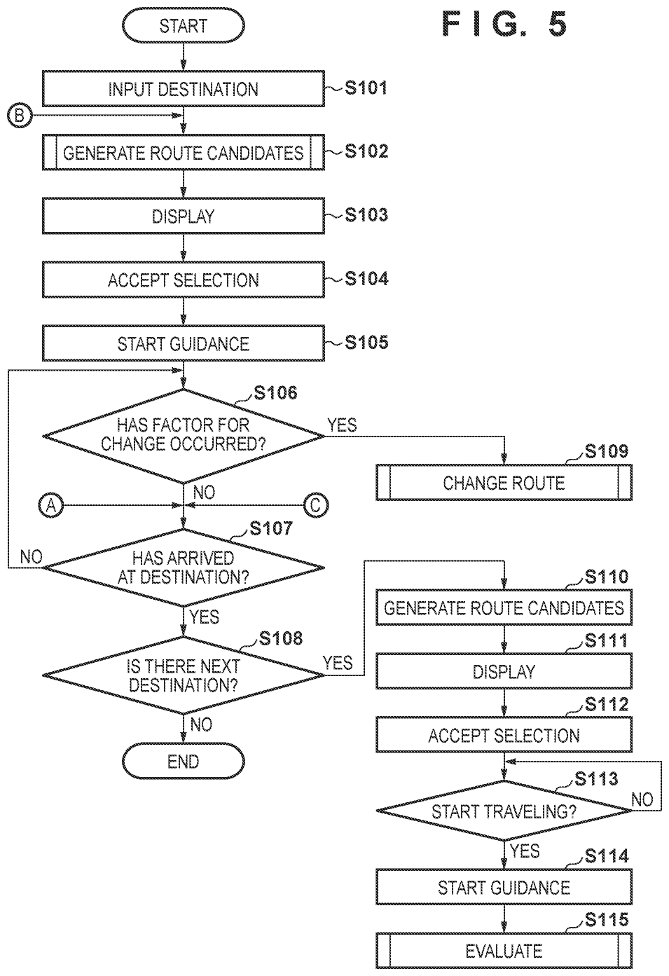

FIG. 5 is a flowchart showing processing of the navigation system according to this embodiment. For example, the processor 301 (for example, a CPU) of the control unit 300 loads a program stored in the ROM into the RAM and executes it, thereby implementing the processing shown in FIG. 5. The processing shown in FIG. 5 is started when the occupant of the vehicle 104 inputs a destination on the display device 217 of the vehicle 104 in a place of departure.

In step S101, the control unit 300 accepts the input of the destination on the navigation device 218. Note that at that time, input of a desired time of arrival at the destination is accepted. If a plurality of points are input as destinations, input of the plurality of destinations and desired times of arrival is accepted as a schedule. In step S102, the control unit 300 generates route candidates up to the destination.

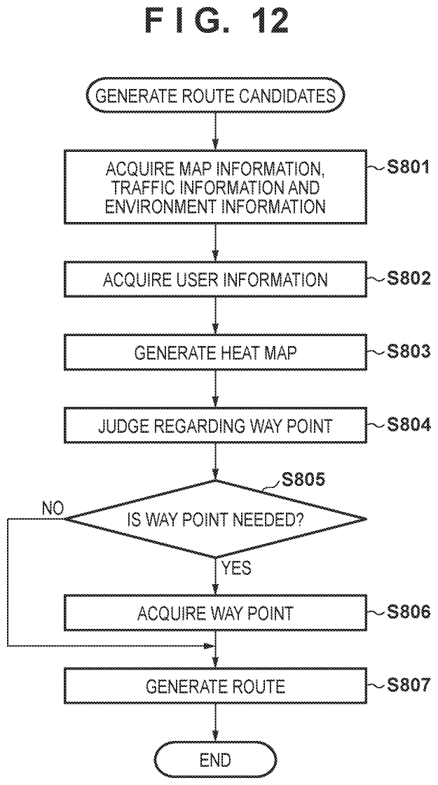

FIG. 12 is a flowchart showing processing of route candidate (route plan) generation. For example, assume that the occupant of the vehicle 104 uses the navigation system 100 for the first time. In this case, any set of the vehicle information 316 and the user information 319 corresponding to the occupant is not held in the database 315 of the server 101.

In step S801, the control unit 300 acquires map information, traffic information, and environment information in the vicinity of the current position (that is, the place of departure) of the vehicle 104 based on the map information 311, the traffic information 312, and the environment information 313. At the current point of time, since any set of the vehicle information 316 and the user information 319 corresponding to the occupant in this example is not held in the database 315 of the server 101, the processes of steps S802 to S804 are skipped.

In step S805, the control unit 300 determines whether a way point is needed until arrival at the destination. Here, since the process of step S804 is skipped, it is determined in step S805 that a way point is not needed.

In step S807, the control unit 300 generates a route up to the destination input in step S101. At this time, based on the map information, the traffic information, and the environment information acquired in step S801, a plurality of route candidates are generated using a plurality of priority standards such as time priority and movement smoothness priority (for example, traffic congestion is absent, an expressway is used, and the like). After that, the processing shown in FIG. 12 is ended.

After the end of the processing shown in FIG. 12, in step S103 of FIG. 5, the control unit 300 displays, on the navigation device 218, the plurality of route candidates generated in step S807. In step S104, the control unit 300 accepts selection by the occupant from the plurality of displayed route candidates. In step S105, the control unit 300 decides the selected route candidate as the route of the vehicle 104 and starts a guide by guidance.

In step S106, the control unit 300 determines whether a factor for a route change has occurred. Determination of the occurrence of a factor for a route change will be described below.

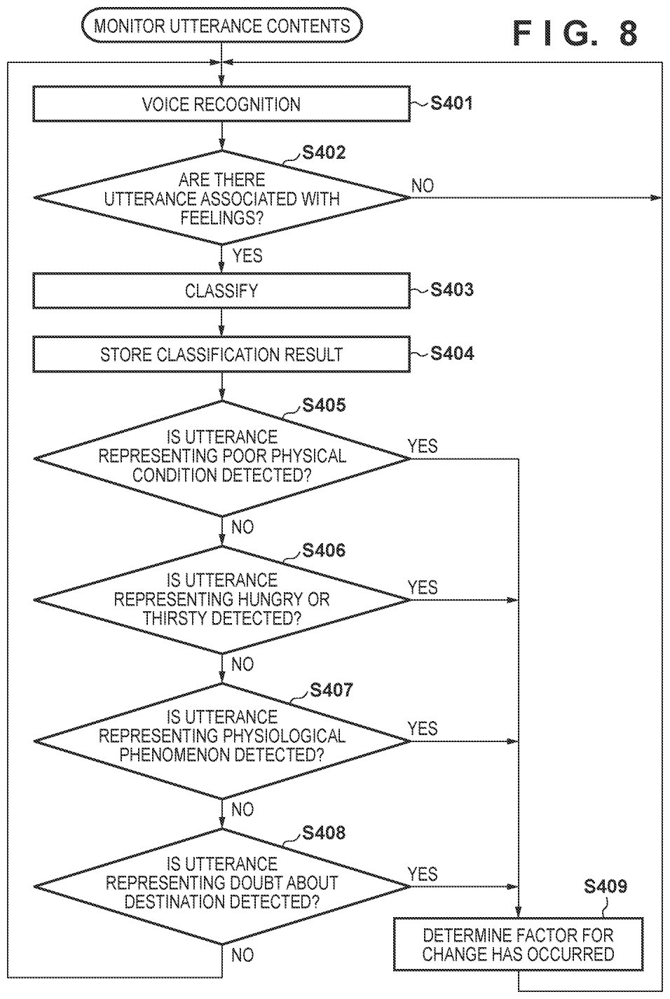

FIGS. 8, 9, 10, and 11 are flowcharts showing processing of determining whether a factor for a route change has occurred. The processing shown in FIGS. 8 to 11 is always executed during reception of the navigation service by the vehicle 104, that is, during the time until the vehicle 104 moves from the place of departure and arrives at the destination. That is, the vehicle 104 always transmits not only vehicle information but also data obtained from the in-vehicle recognition camera 209, the in-vehicle recognition sensor 210, and the microphone 216 to the server 101 and the control unit 300 of the server 101 analyzes those transmitted data, thereby performing the processing shown in FIGS. 8 to 11.

FIG. 8 is a flowchart showing processing of monitoring utterance contents, which is performed by the server 101. For example, the processor 301 (for example, a CPU) of the control unit 300 loads a program stored in the ROM into the RAM and executes it, thereby implementing the processing shown in FIG. 8.

In step S401, the control unit 300 performs voice recognition processing by the voice recognition unit 305 based on voice data transmitted from the vehicle 104. In step S402, the control unit 300 determines whether utterance contents recognized by the voice recognition processing include utterance contents associated with feelings of joy, anger, grief, and pleasure. Utterance contents associated with feelings of joy, anger, grief, and pleasure are, for example, words such as “happy” and “sad”. If such a word is recognized, it is determined that there are utterance contents associated with a feeling. On the other hand, if utterance contents are constituted by only a place name or a fact, for example, if utterance contents include “the block number here is 1” or “turn right”, it is determined that there are no utterance contents associated with a feeling. Upon determining that there are utterance contents associated with a feeling, the process advances to step S403, and the control unit 300 classifies the utterance contents into a predetermined feeling. In step S404, the control unit 300 stores the result as the voice recognition result 320 of the user information 319 in the storage unit 314. At this time, the voice recognition result 320 is stored in association with the vehicle information in a form of, for example, “(position of vehicle 104=latitude X, longitude Y), (time=10:30), feeling classification A (a symbol for identifying a feeling of joy)”. With this arrangement, the feeling information of the occupant is stored in correspondence with the area where the vehicle 104 is traveling. For this reason, for example, when traveling on a seaside roadway, the happy feeling of the occupant can be stored. Upon determining in step S402 that there are no utterance contents associated with a feeling, the processing is repeated from step S401.

In step S405, the control unit 300 determines, based on the utterance contents recognized by the voice recognition processing, whether utterance contents representing a poor physical condition are detected. Here, the utterance contents representing a poor physical condition are, for example, words (or a phrase or a sentence) such as “hurt” and “feel painful”. Upon determining that utterance contents representing a poor physical condition are detected, the process advances to step S409, and the control unit 300 determines that a factor for a route change has occurred. In this case, it is determined in step S106 of FIG. 5 that a factor for a route change has occurred, and the process of step S109 is performed. On the other hand, in FIG. 8, the processing is repeated from step S401. Upon determining in step S405 that utterance contents representing a poor physical condition are not detected, the process advances to step S406.

In step S406, the control unit 300 determines, based on the utterance contents recognized by the voice recognition processing, whether utterance contents representing hunger or thirst are detected. Here, the utterance contents representing hunger or thirst are, for example, words (or a phrase or a sentence) such as “hungry” and “thirsty”. Upon determining that utterance contents representing hunger or thirst are detected, the process advances to step S409, and the control unit 300 determines that a factor for a route change has occurred. In this case, it is determined in step S106 of FIG. 5 that a factor for a route change has occurred, and the process of step S109 is performed. On the other hand, in FIG. 8, the processing is repeated from step S401. Upon determining in step S406 that utterance contents representing hunger or thirst are not detected, the process advances to step S407.

In step S407, the control unit 300 determines, based on the utterance contents recognized by the voice recognition processing, whether utterance contents representing a physiological phenomenon are detected. Here, the utterance contents representing a physiological phenomenon are, for example, words (or a phrase or a sentence) such as “restroom”. Upon determining that utterance contents representing a physiological phenomenon are detected, the process advances to step S409, and the control unit 300 determines that a factor for a route change has occurred. In this case, it is determined in step S106 of FIG. 5 that a factor for a route change has occurred, and the process of step S109 is performed. On the other hand, in FIG. 8, the processing is repeated from step 5401. Upon determining in step S407 that utterance contents representing a physiological phenomenon are not detected, the process advances to step S408.

In step S408, the control unit 300 determines, based on the utterance contents recognized by the voice recognition processing, whether utterance contents representing a doubt about the destination are detected. Here, the utterance contents representing a doubt about the destination are words (or a phrase or a sentence) that deny the destination, such as “amusement park A”, “go”, and “stop”. In step S408, the control unit 300 performs the determination based on, for example, the frequency of the combination of words representing the destination and words that mean a denial and the tone of the voice. Upon determining that utterance contents representing a doubt about the destination are detected, it is judged that the satisfaction of going to the destination is low, the process advances to step S409, and the control unit 300 determines that a factor for a route change has occurred. Even in a case in which it is determined based on the tone, volume, and tempo of voices that there is a trouble between occupants, it is judged that the satisfaction of going to the destination is low, and the control unit 300 determines that a factor for a route change has occurred. Upon determining that a factor for a route change has occurred, it is determined in step S106 of FIG. 5 that a factor for a route change has occurred, and the process of step S109 is performed. On the other hand, in FIG. 8, the processing is repeated from step S401. Upon determining in step S408 that utterance contents representing a doubt about the destination are not detected, the processing is repeated from step S401.

According to the processing shown in FIG. 8, based on the contents uttered inside the vehicle 104, the feeling information of the occupant can be stored together with the information of the route on which the vehicle 104 is traveling. Furthermore, based on the contents uttered inside the vehicle 104, if a factor that needs to change the route up to the destination, such as a poor physical condition, a physiological phenomenon, or a trouble between occupants has occurred, it can be judged that a factor for a route change has occurred. Note that priority is given to each of the processes of steps S405 to S408, and the determination is sequentially executed in accordance with the priority. For example, in the processes of steps S405 to S408, the determination of a poor physical condition in step S405 has the highest priority, and is therefore performed first in the four determination processes. In addition, the determination criterion may be stricter (or looser) for processing of high priority. For example, in step S408, the determination is performed only by detecting the above-described word combination. On the other hand, in step S405, the determination may be performed using not only word detection but also a plurality of elements such as the tone, interval, and tempo. Processing of determining a factor for a route change is not limited to steps S405 to S408, and another determination processing may be performed. In addition, the priority orders of the processes may be changeable.

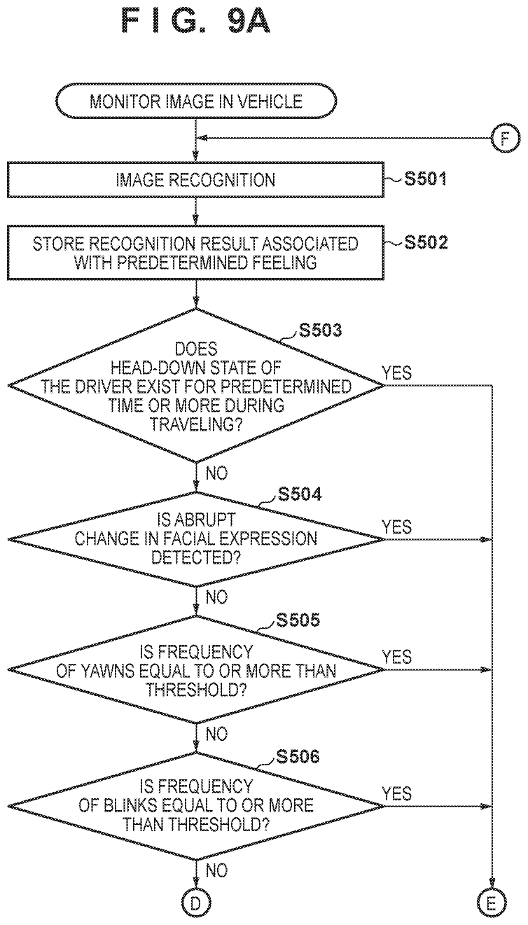

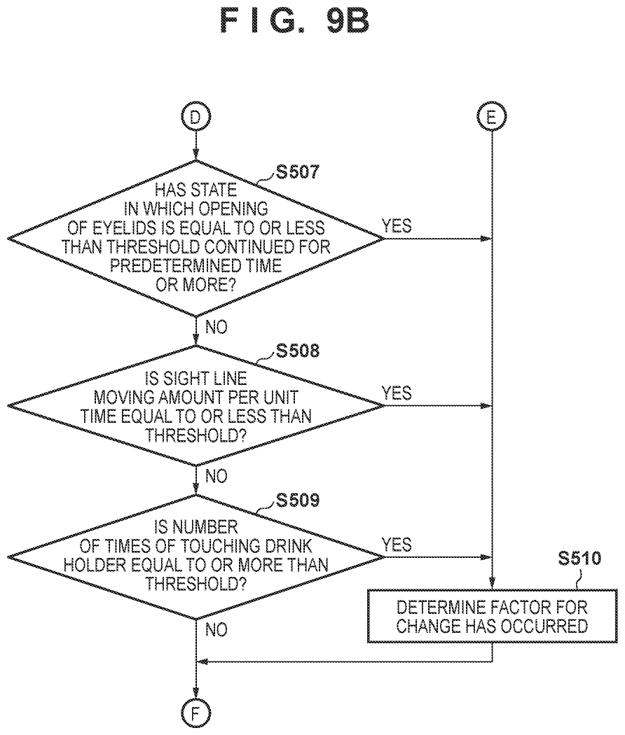

FIGS. 9A and 9B are flowcharts showing processing of monitoring an image in a vehicle, which is performed by the server 101. For example, the processor 301 (for example, a CPU) of the control unit 300 loads a program stored in the ROM into the RAM and executes it, thereby implementing the processing shown in FIGS. 9A and 9B.

In step S501, the control unit 300 performs image recognition processing by the image recognition unit 306 based on image data transmitted from the vehicle 104. In step S502, of recognition results obtained by the image recognition processing, the control unit 300 stores a recognition result associated with a predetermined feeling in the storage unit 314 as the image recognition result 321 of the user information 319. At this time, the image recognition result 321 is stored in association with the vehicle information in a form of, for example, “(position of vehicle 104=latitude X, longitude Y), (time=13:00), feeling classification A (a symbol for identifying a feeling of joy)”.

For example, in step S502, smiling face determination may be performed. In the classification of feelings such as joy, anger, grief, and pleasure, it is considered that the recognizability of a voice is higher than that of an image. Hence, in step S502, a smiling face that is considered to have a particularly high recognizability in the feelings is determined. However, the image recognition result may be classified into each predetermined feeling. Additionally, in step S502, if it is recognized as the result of image recognition that eating/drinking has been done, the recognition result is stored in the storage unit 314 as the state information 322 of the user information 319.

In subsequent steps S503 to S509, the fatigue state of the occupant is determined. In step S503, the control unit 300 determines whether a head-down state of the driver exists for a predetermined time or more during traveling in the image contents recognized by the image recognition processing. Upon determining that a head-down state of the driver exists for a predetermined time or more during traveling, the process advances to step S510, and the control unit 300 determines that a factor for a route change has occurred. In this case, it is determined in step S106 of FIG. 5 that a factor for a route change has occurred, and the process of step S109 is performed. On the other hand, in FIGS. 9A and 9B, the processing is repeated from step S501. Upon determining in step S503 that a head-down state of the driver does not exist for a predetermined time or more during traveling, the process advances to step S504.

In step S504, the control unit 300 determines, based on the image contents recognized by the image recognition processing, whether an abrupt change in the facial expression (surprise or the like) is detected. Upon determining that an abrupt change in the facial expression is detected, the process advances to step S510, and the control unit 300 determines that a factor for a route change has occurred. In this case, it is determined in step S106 of FIG. 5 that a factor for a route change has occurred, and the process of step S109 is performed. On the other hand, in FIGS. 9A and 9B, the processing is repeated from step S501. Upon determining in step S504 that an abrupt change in the facial expression is not detected, the process advances to step S505.

In step S505, the control unit 300 determines, based on the image contents recognized by the image recognition processing, whether the frequency of yawns (the number of times per unit time) is equal to or more than a threshold. Upon determining that the frequency of yawns is equal to or more than the threshold, the process advances to step S510, and the control unit 300 determines that a factor for a route change has occurred. In this case, it is determined in step S106 of FIG. 5 that a factor for a route change has occurred, and the process of step S109 is performed. On the other hand, in FIGS. 9A and 9B, the processing is repeated from step S501. Upon determining in step S505 that the frequency of yawns is not equal to or more than the threshold, the process advances to step S506.

In step S506, the control unit 300 determines, based on the image contents recognized by the image recognition processing, whether the frequency of blinks (the number of times per unit time) is equal to or more than a threshold. Upon determining that the frequency of blinks is equal to or more than the threshold, the process advances to step S510, and the control unit 300 determines that a factor for a route change has occurred. In this case, it is determined in step S106 of FIG. 5 that a factor for a route change has occurred, and the process of step S109 is performed. On the other hand, in FIGS. 9A and 9B, the processing is repeated from step S501. Upon determining in step S506 that the frequency of blinks is not equal to or more than the threshold, the process advances to step S507.

In step S507, the control unit 300 determines, based on the image contents recognized by the image recognition processing, whether a state in which the opening of eyelids is equal to or less than a threshold has continued for a predetermined time or more. Upon determining that a state in which the opening of eyelids is equal to or less than a threshold has continued for a predetermined time or more, the process advances to step S510, and the control unit 300 determines that a factor for a route change has occurred. In this case, it is determined in step S106 of FIG. 5 that a factor for a route change has occurred, and the process of step S109 is performed. On the other hand, in FIGS. 9A and 9B, the processing is repeated from step S501. Upon determining in step S507 that a state in which the opening of eyelids is equal to or less than a threshold has not continued for a predetermined time or more, the process advances to step S508.

In step S508, the control unit 300 determines, based on the image contents recognized by the image recognition processing, whether a sight line moving amount per unit time is equal to or less than a threshold. Upon determining that the sight line moving amount per unit time is equal to or less than the threshold, the process advances to step S510, and the control unit 300 determines that a factor for a route change has occurred. In this case, it is determined in step S106 of FIG. 5 that a factor for a route change has occurred, and the process of step S109 is performed. On the other hand, in FIGS. 9A and 9B, the processing is repeated from step S501. Upon determining in step S508 that the sight line moving amount per unit time is not equal to or less than the threshold, the process advances to step S509.

In step S509, the control unit 300 determines, based on the image contents recognized by the image recognition processing, whether the number of times of touching a drink holder is equal to or more than a threshold. Upon determining that the number of times of touching a drink holder is equal to or more than the threshold, the process advances to step S510, and the control unit 300 determines that a factor for a route change has occurred. In this case, it is determined in step S106 of FIG. 5 that a factor for a route change has occurred, and the process of step S109 is performed. On the other hand, in FIGS. 9A and 9B, the processing is repeated from step S501. Upon determining in step S509 that the number of times of touching a drink holder is not equal to or more than the threshold, the process of step S501 is repeated.

According to the processing shown in FIGS. 9A and 9B, based on the image captured inside the vehicle 104, the feeling information of the occupant can be stored together with the information of the route on which the vehicle 104 is traveling. Furthermore, based on the image captured inside the vehicle 104, if a fatigue state of the occupant involved in driving is detected, it can be judged that a factor for a route change has occurred. Note that priority is given to each of the processes of steps S503 to S509, and the determination is sequentially executed in accordance with the priority. For example, in the processes of steps S503 to S509, the determination of the head-down state of the driver in step S503 is most associated with the driving operation. Hence, the determination has the highest priority and is therefore performed first in the seven determination processes. Determination processing for detecting a fatigue state of the occupant involved in driving is not limited to steps S503 to S509, and another determination processing may be performed. In addition, the priority orders of the processes may be changeable.

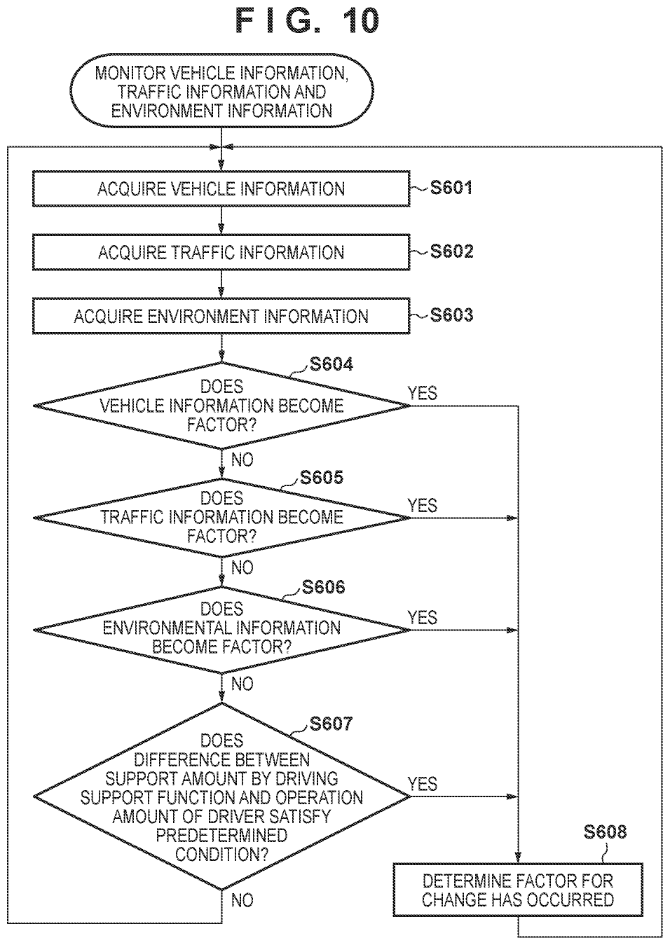

FIG. 10 is a flowchart showing processing of monitoring vehicle information, traffic information, and environment information, which is performed by the server 101. For example, the processor 301 (for example, a CPU) of the control unit 300 loads a program stored in the ROM into the RAM and executes it, thereby implementing the processing shown in FIG. 10.

In step S601, the control unit 300 acquires vehicle information from the vehicle 104 and analyzes it by the vehicle information analysis unit 304. The vehicle information includes, for example, GPS position information, speed information, and energy-related information such as the remaining amount of fuel and the remaining capacity of the in-vehicle battery. In step S602, the control unit 300 acquires traffic information based on the vehicle information received in step S601. For example, the control unit 300 acquires traffic congestion information on the periphery of the position of the vehicle 104 from the traffic information 312. In step S603, the control unit 300 acquires environment information based on the vehicle information received in step S601. For example, the control unit 300 acquires the operating hour information of the amusement park that is the destination from the environment information 313.

In step S604, the control unit 300 determines, based on the result of analysis in step S601, whether the vehicle information becomes a factor for a route change. If arrival at the destination is impossible, or arrival as scheduled is impossible according to the received vehicle information, it is determined that the vehicle information becomes a factor for a route change. For example, if the remaining capacity of the in-vehicle battery of the vehicle 104 is less than a capacity needed up to the destination, it is determined that it becomes a factor for a route change. Upon determining that the vehicle information becomes a factor for a route change, the process advances to step S608, and the control unit 300 determines that a factor for a route change has occurred. In this case, it is determined in step S106 of FIG. 5 that a factor for a route change has occurred, and the process of step S109 is performed. On the other hand, in FIG. 10, the processing is repeated from step S601. Upon determining in step S604 that the vehicle information does not become a factor for a route change, the process advances to step S605.

In step S605, the control unit 300 determines whether the traffic information acquired in step S602 becomes a factor for a route change. If arrival at the destination is impossible, or arrival as scheduled is impossible according to the acquired traffic information, it is determined that the traffic information becomes a factor for a route change. For example, if a traffic congestion has occurred on the route up to the destination, it is determined that the traffic information becomes a factor for a route change. Upon determining that the traffic information becomes a factor for a route change, the process advances to step S608, and the control unit 300 determines that a factor for a route change has occurred. In this case, it is determined in step S106 of FIG. 5 that a factor for a route change has occurred, and the process of step S109 is performed. On the other hand, in FIG. 10, the processing is repeated from step S601. Upon determining in step S605 that the traffic information does not become a factor for a route change, the process advances to step S606.

In step S606, the control unit 300 determines whether the environment information acquired in step S603 becomes a factor for a route change. If arrival at the destination is impossible, or arrival as scheduled is impossible according to the acquired environment information, it is determined that the environment information becomes a factor for a route change. For example, if the amusement park that is the destination is closed, it is determined that the environment information becomes a factor for a route change. Upon determining that the environment information becomes a factor for a route change, the process advances to step S608, and the control unit 300 determines that a factor for a route change has occurred. In this case, it is determined in step S106 of FIG. 5 that a factor for a route change has occurred, and the process of step S109 is performed. On the other hand, in FIG. 10, the processing is repeated from step S601. Upon determining in step S606 that the environment information does not become a factor for a route change, the process advances to step S607.

Alternatively, the determination of step S606 may be performed in accordance with the information or category of the destination. For example, if the destination is an amusement facility such as an amusement park, or an outdoor or open-type facility, and the weather is rain, it may be determined that the environment information becomes a factor for a route change. Alternatively, the determination of step S606 may be performed based on the possibility of implementation of the action plan of the occupant obtained from the destination. For example, the control unit 300 acquires the schedule information of the occupant from SNS information or the like, and acquires purpose information such as a business purpose or an amusement purpose. For example, if the destination is an amusement park, the purpose is a business purpose, and it is judged that the vehicle can arrive at the destination as scheduled, it is judged that the action plan of the occupant can be implemented even if the weather is rain. On the other hand, for example, if the destination is an amusement park, the purpose is an amusement purpose, and it is judged that the vehicle can arrive at the destination as scheduled, it is judged that the possibility of implementation of the action plan of the occupant is low if the weather is rain. As for the degree of lowness, the threshold of the possibility may be decided based on, for example, a probability of precipitation.

In step S607, the control unit 300 determines whether the difference between a support amount by a driving support function and the operation amount of the driver satisfies a predetermined condition. The process of step S607 is performed to estimate the degree of fatigue of the driver. For example, if an operation of crossing over a white line or a yellow line is performed a predetermined number of times or more even if a lane keep assist function steers to return the vehicle 104 into a lane, the control unit 300 determines that the difference satisfies the predetermined condition. Upon determining that the difference satisfies the predetermined condition, the process advances to step S608, and the control unit 300 determines that a factor for a route change has occurred. In this case, it is determined in step S106 of FIG. 5 that a factor for a route change has occurred, and the process of step S109 is performed. On the other hand, in FIG. 10, the processing is repeated from step S601. Upon determining in step S607 that the difference does not satisfy the predetermined condition, the process of step S601 is repeated.

According to the processing shown in FIG. 10, if arrival at the destination is impossible, or arrival as scheduled is impossible based on the vehicle information of the vehicle 104, the traffic information, and the environment information, it can be judged that a factor for a route change has occurred. In addition, if it is estimated based on the vehicle information that the driver is fatigued, it can be judged that a factor for a route change has occurred. Note that the determination processing shown in FIG. 10 is not limited to steps S604 to S607, and another determination processing may be performed.

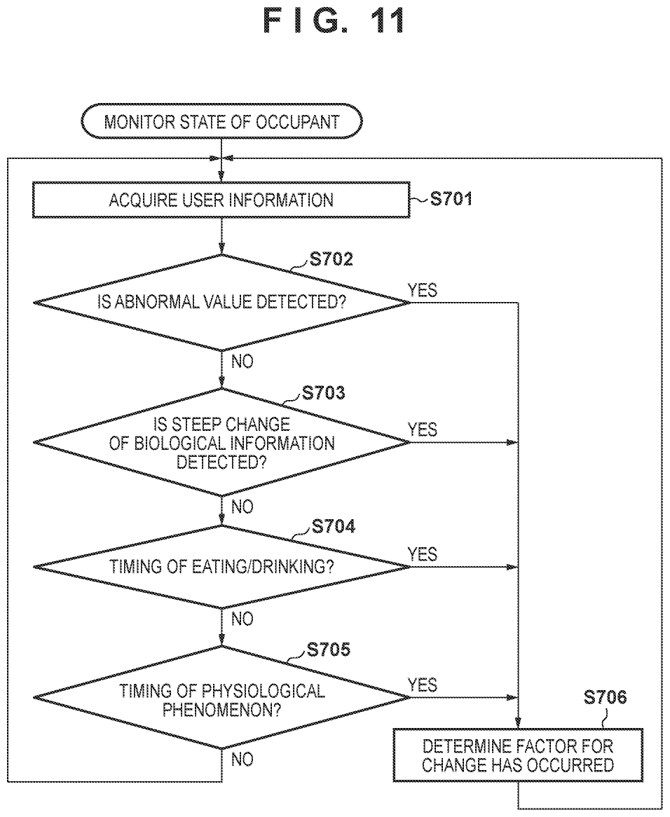

FIG. 11 is a flowchart showing processing of monitoring the state of the occupant, which is performed by the server 101. For example, the processor 301 (for example, a CPU) of the control unit 300 loads a program stored in the ROM into the RAM and executes it, thereby implementing the processing shown in FIG. 11.

In step S701, the control unit 300 acquires the user information 319 of the occupant of the vehicle 104 and analyzes it by the state information analysis unit 307. The user information 319 acquired here is, for example, time information of eating/drinking in the vehicle or in a rest place, which is stored as the state information 322. Alternatively, the acquired user information 319 is, for example, the biological information of the occupant of the vehicle 104, which is stored as the state information 322.

In step S702, the control unit 300 determines whether an abnormal value is detected as the result of analysis of the user information 319 in step S701. For example, if a pulse value exceeds a threshold, it is determined that an abnormal value is detected. Upon determining that an abnormal value is detected, the process advances to step S706, and the control unit 300 determines that a factor for a route change has occurred. In this case, it is determined in step S106 of FIG. 5 that a factor for a route change has occurred, and the process of step S109 is performed. On the other hand, in FIG. 11, the processing is repeated from step S701. Upon determining in step S702 that an abnormal value is not detected, the process advances to step S703.

In step S703, the control unit 300 determines whether a steep change is detected as the result of analysis of the user information 319 in step S701. For example, if an upward variation in the heart rate is equal to or more than a threshold, it is determined that a steep change is detected. Upon determining that a steep change is detected, the process advances to step S706, and the control unit 300 determines that a factor for a route change has occurred. In this case, it is determined in step S106 of FIG. 5 that a factor for a route change has occurred, and the process of step S109 is performed. On the other hand, in FIG. 11, the processing is repeated from step S701. Upon determining in step S703 that a steep change is not detected, the process advances to step S704.

In step S704, the control unit 300 determines whether it is a timing of eating/drinking as the result of analysis of the user information 319 in step S701. For example, based on the state information 322 of the user information 319, if a predetermined time (for example, 4 hrs) has elapsed from the previous timing of eating/drinking (for example, 8:00 am), it is determined that it is a timing of eating/drinking. As the predetermined time at that time, a general arbitrary value may be used, or a value obtained when the state information analysis unit 307 learns the tendency of the eating/drinking cycle in the state information 322 stored previously may be used. In the learning, for example, an eating/drinking cycle obtained as a tendency based on the state information 322 may be corrected based on utterance contents by the voice recognition result 320. That is, if a route is generated using the learning result of the eating/drinking cycle, but contents that deny the route are detected from the utterance contents of the occupant, correction may be done to make the cycle long or short. Upon determining that it is a timing of eating/drinking, the process advances to step S706, and the control unit 300 determines that a factor for a route change has occurred. In this case, it is determined in step S106 of FIG. 5 that a factor for a route change has occurred, and the process of step S109 is performed. On the other hand, in FIG. 11, the processing is repeated from step S701. Upon determining in step S704 that it is not a timing of eating/drinking, the process advances to step S705.

In step S705, the control unit 300 determines whether it is a timing of a physiological phenomenon as the result of analysis of the user information 319 in step S701. For example, based on the state information 322 of the user information 319, if a predetermined time has elapsed from the previous timing of a break in a restroom, it is determined that it is a timing of a physiological phenomenon. As the predetermined time at that time, a general arbitrary value may be used, or a value obtained when the state information analysis unit 307 learns the tendency of the physiological phenomenon cycle in the state information 322 stored previously may be used. In the learning, for example, a physiological phenomenon cycle obtained as a tendency based on the state information 322 may be corrected based on utterance contents by the voice recognition result 320. That is, if a route is generated using the learning result of the physiological phenomenon cycle, but contents that deny the route are detected from the utterance contents of the occupant, correction may be done to make the cycle long or short. Upon determining that it is a timing of a physiological phenomenon, the process advances to step S706, and the control unit 300 determines that a factor for a route change has occurred. In this case, it is determined in step S106 of FIG. 5 that a factor for a route change has occurred, and the process of step S109 is performed. On the other hand, in FIG. 11, the processing is repeated from step S701. Upon determining in step S705 that it is not a timing of a physiological phenomenon, the process of step S701 is repeated.

According to the processing shown in FIG. 11, if something wrong is found in the state of the occupant, it can be judged that a factor for a route change has occurred. In addition, if it is determined, based on the time information of previous eating/drinking or a break in a restroom by the occupant of the vehicle 104, that it is a timing of eating/drinking or a break in a restroom, it can be judged that a factor for a route change has occurred. Note that the determination processing shown in FIG. 11 is not limited to steps S702 to S705, and another determination processing may be performed. For example, in the processes shown in FIGS. 8 to 10, it may be impossible to detect the degree of fatigue of the occupant. Hence, it may be determined whether a predetermined time at which the occupant is considered to start feeling fatigued has elapsed after the start of traveling of the vehicle 104. If it is determined that the predetermined time has elapsed, it may be judged that a factor for a route change has occurred.

The processes shown in FIGS. 8 to 11 are always performed in parallel. Hence, if there are a plurality of occupants, a plurality of factors for a route change may occur. For example, a head-down state is detected for the driver in step S503 of FIG. 9A, and at the same time, an utterance representing hunger or thirsty is detected in FIG. 8. In such a case, priority orders are determined in advance for the plurality of factors. The priority order may comply with urgency. For example, in the above-described example, the priority of detection of the head-down state of the driver is set higher than that of detection of an utterance representing hunger or thirsty.

Referring back to FIG. 5, upon determining in step S106 that a factor for a route change has occurred, processing of route change in step S109 is performed.

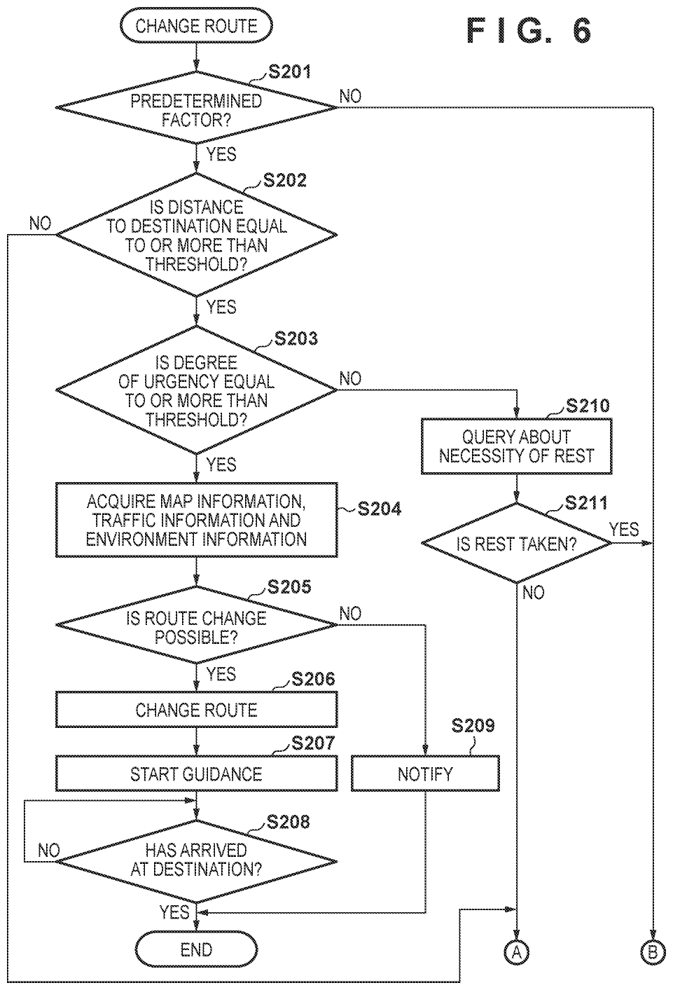

FIG. 6 is a flowchart showing processing of route change. For example, the processor 301 (for example, a CPU) of the control unit 300 loads a program stored in the ROM into the RAM and executes it, thereby implementing the processing shown in FIG. 6.

In step S201, the control unit 300 determines whether a factor for a route change includes a predetermined factor. Here, the predetermined factor is a factor whose priority described above is a predetermined level or more, like a poor physical condition of the occupant, for which, for example, it is determined in step S703 of FIG. 11 that a steep change in biological information is detected. Upon determining in step S201 that a factor for a route change includes a predetermined factor, the process advances to step S202. Upon determining that a factor for a route change does not include a predetermined factor, the process of step S102 in FIG. 5 is repeated.

A case in which the process advances to step S102 in FIG. 5 after it is determined in step S201 that a predetermined factor is not included will be described. Such a case is, for example, a case in which an utterance representing hunger or thirsty is detected in step S406 of FIG. 8. Such a case is a case in which there is no urgency even if a factor for a route change has occurred. In this case, in this embodiment, a route change on which the taste of the occupant of the vehicle 104 is reflected is performed.

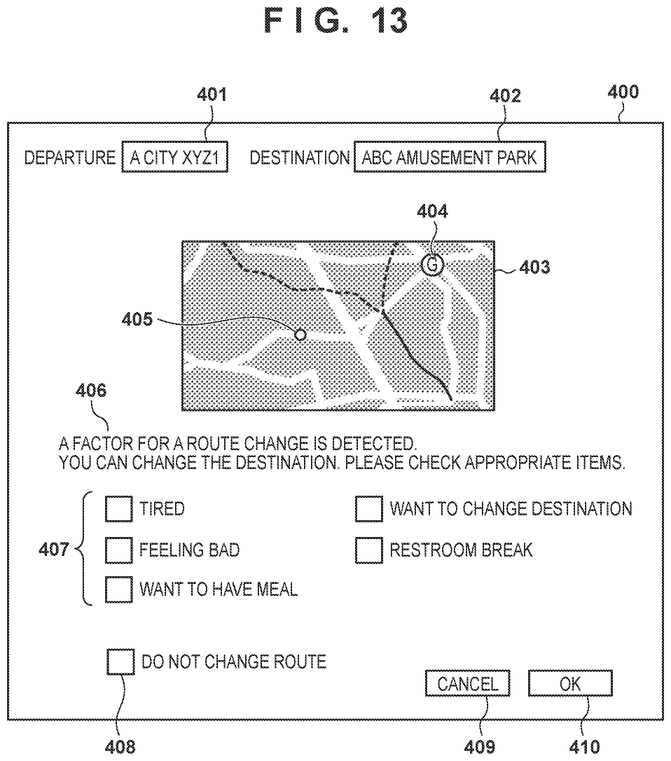

As the route change, a route change to solve the factor for the occurrence of a route change is performed. For example, if it rains, a route to an indoor place is searched for. For example, if an utterance representing hunger or thirsty is detected, a route to a restaurant is searched for. For example, if a fatigue state of the occupant is detected, a route to a place where it is possible to take a rest, for example, a service area is searched for. For example, if an utterance representing a doubt about the destination is detected in step S408 of FIG. 8, a route to another place that is similar in terms of the scale or details of the facility is searched for. In addition, to specify one of the plurality of types of searches, a screen 400 shown in FIG. 13 may be displayed in the vehicle 104. A place of departure is displayed in an item 401, and a destination is displayed in an item 402. In a map 403, a mark 404 corresponding to the destination in the item 402 is displayed. A mark 405 represents the current position of the vehicle 104.

On the screen 400, a message 406 “A factor for a route change is detected. You can change the destination. Please check appropriate items.” is displayed. A plurality of selectable items are displayed in an item 407, and the occupant of the vehicle 104 can arbitrarily select an item. At this time, the occupant can check a plurality of items. If a factor for the occurrence of a route change is detected, a screen as shown in FIG. 13 is displayed, thereby confirming the probability of the factor of the occurrence. In addition, the occupant can select not to change the route by checking an item 408. When a cancel button 409 is pressed, the setting contents on the screen 400 are canceled. When an OK button 410 is pressed, the setting contents are transmitted to the server 101.

In addition, a factor for a route change and a corresponding reason may be displayed in place of the message 406 or together with the message 406. For example, if it is determined in step S505 of FIG. 9A that the frequency of yawns is equal to or more than the threshold, and it is recognized, based on the state information 322, that eating/drinking was done within a predetermined time, a message “You look sleepy. Do you want to take a rest?” may be displayed in the vehicle 104. This arrangement can give the driver a motivation to take a rest.

Step S102 of FIG. 5 after it is determined in step S201 that a predetermined factor is not included will be described with reference to FIG. 12.

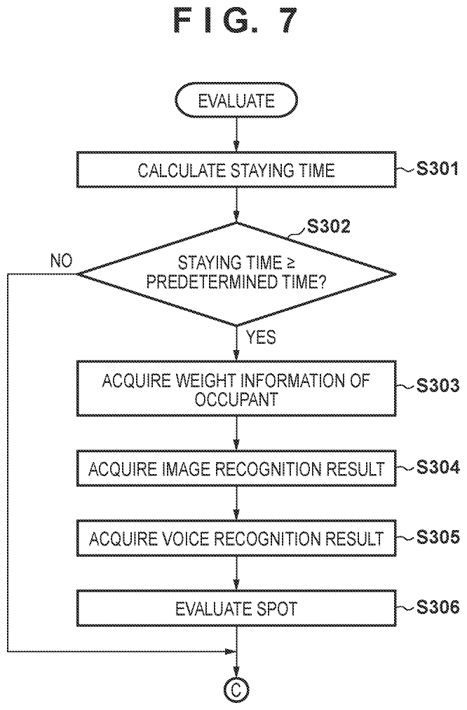

In step S801, the control unit 300 acquires map information, traffic information, and environment information in the vicinity of the current position of the vehicle 104 based on the map information 311, the traffic information 312, and the environment information 313. In step S802, the control unit 300 acquires the user information 319. The user information 319 acquired here is, for example, the taste of the user analyzed by the user information analysis unit 308. In addition, the acquired user information 319 is, for example, a result of spot evaluation performed in step S306 of FIG. 7 to be described later. Here, a spot evaluation is evaluation information of the occupant obtained from an image recognition result and a voice recognition result concerning a place that the vehicle 104 previously visited. Spot evaluation will be described later.

In step S803, the control unit 300 generates a heat map based on the map information, the traffic information, and the environment information acquired in step S801 and the user information 319 acquired in step S802. In this embodiment, the heat map is a route map on which a spot preferred by the user can be displayed. In this embodiment, the taste of the occupant analyzed by the user information analysis unit 308 is reflected. For example, a restaurant that is preferred by general users and has a high similarity to the taste obtained by analyzing the voice recognition result 320 and the image recognition result 321 by the user information analysis unit 308 is searched for on the Internet. For example, if a restaurant (spot) that the vehicle 104 visited previously was highly evaluated by the occupant, a restaurant whose charge system or store scale is similar to that of the restaurant is searched for. The control unit 300 may exclude a closed restaurant from the processing target based on the environment information 313.

In step S804, the control unit 300 judges whether a way point is needed. The judgment in step S804 is performed based on the vehicle information 316 and the user information 319. For example, if an utterance representing a doubt about the destination is detected as a factor for a route change in step S408, a change of the destination is selected on the screen 400 by the occupant to change the route, and the eating/drinking timing of the occupant is close as the state information 322, it is judged that a way point for a meal is needed. In this case, the control unit 300 acquires the position of a restaurant based on the map information 311, the traffic information 312, and the environment information 313 in step S806, and sets a route to arrive at the restaurant of the taste of the occupant at the eating/drinking timing of the occupant in step S807. Here, if the factor for a route change can be solved by arriving at the destination because the destination is a restaurant or the like, it may be judged that a way point is not needed.

If a change of the destination is selected on the screen 400 by the occupant to change the route, as described above, and the frequency of the timing of a physiological phenomenon is high based on the state information 322 of the user information 319, the control unit 300 judges that a way point for a break in a restroom is needed. In this case, the control unit 300 acquires the position of a rest place based on the map information 311, the traffic information 312, and the environment information 313 in step S806, and sets a route in step S807.

If a change of the destination is selected on the screen 400 by the occupant to change the route, as described above, and the remaining capacity of the in-vehicle battery may become equal to or less than a threshold due to the route change based on the energy-related information 318 of the vehicle information 316, the control unit 300 judges that the vehicle needs to stop by a charge station to replenish energy. In this case, the control unit 300 acquires the position of a charge station based on the map information 311, the traffic information 312, and the environment information 313 in step S806, and sets a route in accordance with the remaining amount represented by the energy-related information 318 in step S807.

In step S807, the control unit 300 generates a route based on the heat map generated in step S803 and the way point if the way point is acquired in step S806. At this time, based on the map information, the traffic information, and the environment information acquired in step S801, a plurality of route candidates are generated using a plurality of priority standards such as time priority and movement smoothness priority. After that, the processing shown in FIG. 12 is ended. After the processing shown in FIG. 12, in step S103 of FIG. 5, the control unit 300 displays, on the navigation device 218, the plurality of route candidates generated in step S807. In step S104, the control unit 300 accepts selection by the occupant from the plurality of displayed route candidates. In step S105, the control unit 300 decides the selected route candidate as the route of the vehicle 104 and starts a guide by guidance.

In guidance in a case in which a way point is added, information about the traveling route may be more emphasized and notified. For example, the occupant is notified of a message “If you miss this way point, you cannot take a rest for 1 hr or more because the next way point to take a break in a restroom exists 50 km ahead”. This arrangement can urge the occupant to take an action such as taking a rest reliably at the added way point.

As described above, in a case in which a factor for a route change occurs, and the route is to be changed, if the factor has no urgency (the priority is low), a route change to reflect the taste of the occupant can be performed. In addition, if a way point is necessary when changing the route, route candidates can be generated after adding a way point.

A case in which the process advances to step S202 in FIG. 6 after it is determined in step S201 that a predetermined factor is included will be described. Such a case is, for example, a case in which an abnormal value of biological information is detected in step S702 of FIG. 11. Such a case is a case in which a route change is urgent. In this case, in step S202, the control unit 300 first determines whether the distance to the destination is equal to or more than a threshold. The threshold may be set depending on the factor for a route change. For example, if the factor is a factor concerning biological information, a short distance of several tens of m is set. Upon determining that the distance to the destination is not equal to or more than the threshold, it only a little way to the destination. Hence, the process advances to step S107 of FIG. 5 to continue the guide by guidance to the destination. On the other hand, upon determining that the distance to the destination is equal to or more than the threshold, the process advances to step S203.

In step S203, the control unit 300 determines whether the degree of urgency of the route change is equal to or more than a threshold. The control unit 300 performs the determination based on the priority of the factor for a route change, which has occurred. That is, the degree of urgency of the route change, for which it is determined in step S201 that the factor for the route change includes a predetermined factor (it is determined that urgency exists), is discriminated by the determination of step S203. For example, if it is determined in step S508 of FIG. 9B that the factor for the route change is the sight line moving amount per unit time, which is equal to or less than a threshold, it is determined, in step S203 based on the priority, that the degree of urgency of the route change is not equal to or more than the threshold. In step S210, the control unit 300 notifies the occupant of the vehicle 104 of a message for making a query about the necessity of a rest. The notification may be displayed on the navigation device 218 or the display device 217, or may be output as a voice to the speaker 215. The message at that time complies with the factor for a route change. For example, if it is determined in step S508 of FIG. 9B that the sight line moving amount per unit time is equal to or less than the threshold, the occupant is notified of a message. “You look fatigued. Do you want to take a rest?” In step S211, upon receiving a signal representing that an instruction to take a rest is accepted from the occupant of the vehicle 104, the control unit 300 advances to step S102 of FIG. 5 to perform route candidate generation shown in FIG. 12 as described above. In this case, for example, if a rest spot that the vehicle 104 visited previously exists, a spot similar to the rest spot in terms of the scale or details is searched for.

As described above, in a case in which a factor for a route change occurs, and the route is to be changed, if it is determined that the factor has urgency, but the degree of urgency is less than a threshold, a route change to reflect the taste of the occupant can be performed.

In addition, the contents of processing shown in FIG. 12, which is performed upon determining in step S201 that the factor for a route change does not include a predetermined factor, and the contents of processing shown in FIG. 12, which is performed upon receiving a signal representing that an instruction to take a rest is accepted in step S211 may be different. For example, in the latter case, since the urgency is higher than in the former case, the degree of reflecting the taste of the occupant may be made smaller than in the former case. For example, if a rest spot similar to the taste of the occupant is not found, a rest spot that is generally popular on the Internet may be searched for.

Upon receiving a signal representing that an instruction not to take a rest is accepted from the occupant of the vehicle 104 in step S211, the control unit 300 advances to step S107 of FIG. 5 to continue the guide by guidance to the destination.

If the degree of urgency of the route change is equal to or more than the threshold in step S203, and if, for example, an abnormal value of biological information is detected in step S702 of FIG. 11, the process advances to step S204, and the control unit 300 acquires map information, traffic information, and environment information in the vicinity of the position of the vehicle 104 with reference to the map information 311, the traffic information 312, and the environment information 313. For example, the control unit 300 searches for a hospital, a charge station, or the like on the periphery. In step S205, the control unit 300 determines whether a route change is possible. For example, if there is a traffic regulation or the like, and the vehicle cannot arrive at any hospital, for example, a message “Movement by vehicle may be impossible. Please contact by phone” is transmitted to the vehicle 104 to make a notification to the occupant. After that, the processing shown in FIG. 6 is ended, and the navigation service is ended.

Upon determining in step S205 that a route change is possible, the control unit 300 starts a guide by guidance in step S207, and continues the guide by guidance until it is determined in step S208 that the vehicle has arrived at the destination. Upon determining in step S208 that the vehicle has arrived at the destination, the processing shown in FIG. 6 is ended, and the navigation service is ended.

Referring back to FIG. 5, upon determining in step S106 that a factor for a route change has not occurred, or if the process of step S109 is performed, in step S107, the control unit 300 determines, based on the vehicle information of the vehicle 104, whether the vehicle has arrived at the destination. Upon determining that the vehicle has not arrived at the destination, the process of step S106 is repeated. On the other hand, upon determining that the vehicle has arrived at the destination, the process advances to step S108 to determine, based on the input in step S101, whether the next destination exists. Note that here, it may be asked with the occupant of the vehicle 104 whether the next destination exists. Upon determining that the next destination does not exist, the processing shown in FIG. 5 is ended, and the navigation service is ended. On the other hand, upon determining that the next destination exists, the process advances to step S110 to perform route candidate generation in FIG. 12.

In step S111, the control unit 300 displays the plurality of route candidates generated in step S807 on the navigation device 218. In step S112, the control unit 300 accepts selection by the occupant from the plurality of displayed route candidates, and decides the selected route candidate as the route of the vehicle 104. In step S113, the control unit 300 stands by for the start of traveling of the vehicle 104. Upon determining that traveling is started, the process advances to step S114 to start a guide by guidance. After step S114, the staying place is evaluated in step S115.

FIG. 7 is a flowchart showing processing of evaluation of a staying place in step S115. For example, the processor 301 (for example, a CPU) of the control unit 300 loads a program stored in the ROM into the RAM and executes it, thereby implementing the processing shown in FIG. 7.

In step S301, the control unit 300 calculates the staying time of the vehicle 104 in the staying place (spot). In step S302, the control unit 300 determines whether the calculated staying time is equal to or more than a predetermined time. Here, if the staying time is not equal to or more than the predetermined time, the staying place is excluded from the target of evaluation in FIG. 7, and the process advances to step S107 of FIG. 5. On the other hand, upon determining that the staying time is equal to or more than the predetermined time, the process advances to step S303.

In step S303, the control unit 300 acquires the weight information of the occupant of the vehicle 104 and analyzes it by the state information analysis unit 307. For example, if the weight of the occupant has increased as the result of analysis, it is judged that the occupant has had a meal. If the weight of the occupant has decreased as the result of analysis, it is judged that the occupant has taken a break in a restroom. The control unit 300 records the result of analysis in step S303 as the information of the timing of eating/drinking or the timing of a physiological phenomenon in the state information 322 of the user information 319, or updates the state information 322. In step S303, concerning whether the occupant has had a meal or taken a break in a restroom, a query may be made to the occupant of the vehicle 104, and the judgment may be done based on the answer.

In step S304, the control unit 300 acquires a result of image recognition by the image recognition unit 306. In step S305, the control unit 300 acquires a result of voice recognition by the voice recognition unit 305.

In step S306, the control unit 300 analyzes the taste of the occupant concerning the staying place by the user information analysis unit 308 based on the image recognition result 321 acquired in step S304 and the voice recognition result 320 acquired in step S305. For example, if positive words (or a phrase or a sentence) such as “it was fun”, a laughter, or a smiling face is detected, information concerning the staying place (for example, information of the facility) is acquired as the information of the taste of the user and stored as the user information 319. If negative words (or a phrase or a sentence) such as “it was not fun” or “I'm tired”, or a tendency such as a silence or a face without an expression change is detected, information concerning the staying place is not acquired as the information of the taste of the user. If the information is stored as the taste of the user, the information is deleted. After that, the process advances to step S107 of FIG. 5.

In this way, the information of the taste of the occupant can be stored or updated based on the reaction of the occupant after the vehicle 104 arrived at the destination and then departed from the destination.

A case in which the vehicle 104 arrives at the destination, the navigation service is ended, and the occupant starts executing the navigation service anew later will be described. If the input of the destination is accepted in step S101 of FIG. 5, in step S102, a route candidate to the destination is generated. At this time, a set of the vehicle information 316 and the user information 319 corresponding to the occupant is held in the database 315 of the server 101. Hence, in this case, the processes of steps S802 to S804 are executed. For example, a route (for example, a seaside roadway) which the vehicle 104 traveled and for which the occupant of the vehicle 104 uttered “it is fun” is generated as a route candidate. In addition, for example, if it is judged that the frequency is high as the result of learning the timing of a physiological phenomenon, it is judged, according to the distance to the destination, that a break in a restroom is necessary, and a way point is acquired in step S806. For example, if the eating/drinking timing will come until arrival at the destination, it is judged that a meal rest is necessary, and a way point is acquired in step S806.

As described above, according to this embodiment, a route can flexibly be changed in accordance with a factor that occurs during traveling to a destination.

### Summary of Embodiment

According to this embodiment, there is provided a control apparatus (300) comprising a generation circuit (309) configured to generate a route plan of a vehicle, and a control circuit (300) configured to control the generation circuit to change the route plan of the vehicle generated by the generation circuit because of at least one of vehicle information of the vehicle, information of an occupant of the vehicle, and information concerning an environment on the route plan as a factor.

With the arrangement, the traveling route can be changed in accordance with a factor that occurs during traveling of the vehicle.

The control apparatus further comprises a first monitoring circuit (FIG. 10) configured to monitor the vehicle information, and if the vehicle information satisfies a condition as the factor, the control circuit controls the generation circuit to change the route plan of the vehicle generated by the generation circuit. The vehicle information includes energy-related information (318). In addition, the energy-related information includes at least one of a remaining amount of a fuel and a remaining capacity of an in-vehicle battery, and if it is determined, based on the energy-related information, that the vehicle cannot arrive at a destination, the control circuit determines that the vehicle information satisfies the condition as the factor, and controls the generation circuit to change the route plan of the vehicle generated by the generation circuit.

With the arrangement, for example, if the remaining capacity of the in-vehicle battery of the vehicle is equal to or less than a threshold, the traveling route can be changed.

Additionally, the control apparatus further comprises a second monitoring circuit (FIGS. 8 and 9) configured to monitor the information of the occupant, and if the information of the occupant satisfies a condition as the factor, the control circuit controls the generation circuit to change the route plan of the vehicle generated by the generation circuit. The control apparatus further comprises an image recognition circuit configured to perform image recognition using image data concerning the occupant, and a voice recognition circuit configured to perform voice recognition using voice data concerning the occupant, and the information of the occupant includes at least one of image information, voice information, and biological information of the occupant.

With the arrangement, for example, the traveling route can be changed based on a change in the biological information of the occupant. In addition, for example, the traveling route can be changed based on the image recognition result or the voice recognition result of the occupant. Additionally, if a physical condition of the occupant recognized based on the information of the occupant satisfies the condition as the factor, the control circuit controls the generation circuit to change the route plan of the vehicle generated by the generation circuit. The physical condition includes at least one of a fatigue state and hunger.

With the arrangement, for example, if the fatigue state of the occupant is recognized, the traveling route can be changed.

In addition, if a behavior of the occupant recognized based on the information of the occupant satisfies the condition as the factor, the control circuit controls the generation circuit to change the route plan of the vehicle generated by the generation circuit. The behavior of the occupant is classified into a predetermined feeling and stored.

With the arrangement, for example, if an utterance of the occupant is negative for the destination, the traveling route can be changed.

In addition, when changing a traveling route of the vehicle by the control circuit, a way point to the destination is added based on the information of the occupant. When adding the way point to the destination, if it is judged that one of refueling and power feed for the vehicle is necessary, a way point at which one of the refueling and the power feed is possible is added.

With the arrangement, for example, if it is judged that power feed for the vehicle is necessary, a charge station can preferentially be added as a way point.

The control apparatus further comprises a third monitoring circuit (FIG. 10) configured to monitor the information concerning the environment, and if the information concerning the environment satisfies a condition as the factor, the control circuit controls the generation circuit to change the route plan of the vehicle generated by the generation circuit. The information concerning the environment includes at least one of traffic information, facility information, weather information, and disaster information.

With the arrangement, for example, if a disaster has occurred, the traveling route can be changed.

The control apparatus further comprises an acquisition circuit configured to acquire an action plan of the occupant at a destination on the route plan of the vehicle generated by the generation circuit, and a first judgment circuit configured to judge a possibility of implementation of the action plan based on the information concerning the environment corresponding to at least one of the destination and a way point to the destination. The control apparatus further comprises a notification circuit configured to notify the occupant of a candidate of another destination or way point if the first judgment circuit judges that the possibility of implementation of the action plan is less than a predetermined threshold.

With the arrangement, for example, it can be judged, based on the weather, whether the action plan (play or negotiation for a business purpose) of the occupant at the destination can be implemented. In addition, when changing the traveling route, the occupant of the vehicle can be notified of it.

The invention is not limited to the foregoing embodiments, and various variations/changes are possible within the spirit of the invention.

What is claimed is:

1. A control apparatus comprising:
a generation circuit configured to generate a route plan of a vehicle; and
a control circuit configured to control the generation circuit to change the route plan of the vehicle generated by the generation circuit because of at least one of vehicle information of the vehicle, information of an occupant of the vehicle, and information concerning an environment on the route plan as a factor.

2. The apparatus according to claim 1, further comprising a first monitoring circuit configured to monitor the vehicle information,
wherein if the vehicle information satisfies a condition as the factor, the control circuit controls the generation circuit to change the route plan of the vehicle generated by the generation circuit.

3. The apparatus according to claim 2, wherein the vehicle information includes energy-related information.

4. The apparatus according to claim 2, wherein the energy-related information includes at least one of a remaining amount of a fuel and a remaining capacity of an in-vehicle battery, and
if it is determined, based on the energy-related information, that the vehicle cannot arrive at a destination, the control circuit determines that the vehicle information satisfies the condition as the factor, and controls the generation circuit to change the route plan of the vehicle generated by the generation circuit.

5. The apparatus according to claim 1, further comprising a second monitoring circuit configured to monitor the information of the occupant,
wherein if the information of the occupant satisfies a condition as the factor, the control circuit controls the generation circuit to change the route plan of the vehicle generated by the generation circuit.

6. The apparatus according to claim 5, further comprising:
an image recognition circuit configured to perform image recognition using image data concerning the occupant; and
a voice recognition circuit configured to perform voice recognition using voice data concerning the occupant,
wherein the information of the occupant includes at least one of image information of the occupant obtained from a result of recognition by the image recognition circuit, voice information obtained from a result of recognition by the voice recognition circuit, and biological information.

7. The apparatus according to claim 5, wherein if a physical condition of the occupant recognized based on the information of the occupant satisfies the condition as the factor, the control circuit controls the generation circuit to change the route plan of the vehicle generated by the generation circuit.

8. The apparatus according to claim 7, wherein the physical condition includes at least one of a fatigue state and hunger.

9. The apparatus according to claim 5, wherein if a behavior of the occupant recognized based on the information of the occupant satisfies the condition as the factor, the control circuit controls the generation circuit to change the route plan of the vehicle generated by the generation circuit.

10. The apparatus according to claim 9, wherein the behavior of the occupant is classified into a predetermined feeling and stored.

11. The apparatus according to claim 5, wherein when changing a traveling route of the vehicle by the control circuit, a way point to a destination is added based on the information of the occupant.

12. The apparatus according to claim 11, wherein when adding the way point to the destination, if it is judged that one of refueling and power feed for the vehicle is necessary, a way point at which one of the refueling and the power feed is possible is added.

13. The apparatus according to claim 1, further comprising a third monitoring circuit configured to monitor the information concerning the environment,
wherein if the information concerning the environment satisfies a condition as the factor, the control circuit controls the generation circuit to change the route plan of the vehicle generated by the generation circuit.

14. The apparatus according to claim 13, wherein the information concerning the environment includes at least one of traffic information, facility information, weather information, and disaster information.

15. The apparatus according to claim 13, further comprising:
an acquisition circuit configured to acquire an action plan of the occupant at a destination on the route plan of the vehicle generated by the generation circuit; and
a first judgment circuit configured to judge a possibility of implementation of the action plan based on the information concerning the environment corresponding to at least one of the destination and a way point to the destination.

16. The apparatus according to claim 15, further comprising a notification circuit configured to notify the occupant of a candidate of another destination or way point if the first judgment circuit judges that the possibility of implementation of the action plan is less than a predetermined threshold.

17. A control method executed by a control apparatus, comprising:
generating a route plan of a vehicle; and
controlling to change the generated route plan of the vehicle because of at least one of vehicle information of the vehicle, information of an occupant of the vehicle, and information concerning an environment on the route plan as a factor.

18. A non-transitory computer-readable storage medium storing a program configured to cause a computer to operate to:
generate a route plan of a vehicle; and
control to change the generated route plan of the vehicle because of at least one of vehicle information of the vehicle, information of an occupant of the vehicle, and information concerning an environment on the route plan as a factor.
